(19) United States
(12) Patent Application Publication
(10) Pub. No.: US 2004/0103427 A1
(43) Pub. Date: May 27, 2004

(54) Content delivery and data procurement system and methods of use and doing business

(76) Inventors: David E. Fritsche JR., Reno, NV (US); Robert A. Wilson II, Reno, NV (US)

Correspondence Address: Robert C. Ryan, Nath & Associates PLLC, 6th Floor, 1030 15th St. N.W., Washington, DC, 20005, US

(21) Appl. No.: 10/716,318

(22) Filed: Nov. 17, 2003

Related U.S. Application Data
(60) Provisional application No. 60/426,471, filed on Nov. 15, 2002.
(60) Provisional application No. 60/426,474, filed on Nov. 15, 2002.

(51) Int. Cl. H04N 7/16; H04N 7/173; G11B 15/467; G11B 15/46; G11B 15/18; G11B 5/09; H04H 9/00; G11B 27/22

(52) U.S. Cl. 725/9; 725/135; 369/47.48; 725/132; 725/140

(57) ABSTRACT

Systems and methods of distributing multimedia marketing content and collecting marketing data by generating a plurality of autoloading storage devices, providing a multimedia content serving system, sending the storage devices to remote users, causing automatic linking through a network between remote users and the content serving system, updating the static content of a remote user's storage device such as a CD-ROM or DVD by passing variable data, text, pictures, audio and video through a Local-Area Network or Wide-Area Network such as the Internet and to join that data to the contents of the CD-ROM or DVD in a seamless manner to the CD-ROM or DVD user. Further systems and methods for embedding data collection on a storage device such as a CD-ROM or DVD that is used to pass information through a Local-Area Network or Wide-Area Network, such as the Internet. The data collection forms or variable data are stored on the CD-ROM or DVD in a computer software program. The information from the forms or variable data is received through a network such as the Internet at a central storage media and merged into a database.

### CROSS-REFERENCE TO RELATED PATENT APPLICATIONS

Under, 35 U.S.C. §119(e), Applicants claim the benefit of the filing dates of provisional patent application Nos. 60/426,471 and 60/426,474, which were both filed on Nov. 15, 2002 and which provisional applications are incorporated herein by reference in their entireties.

### FIELD OF THE INVENTION

This invention relates to systems and methods for distributing information to a remote user and procuring information from a remote user or the remote user's apparatus.

### BACKGROUND

Industry has long sought to develop effective, economical, and easily implemented systems and methods of delivering product or service marketing or advertising information to consumers. Marketing entities and those whom they serve have also long sought to develop systems and methods for collecting marketing and other information from consumers.

One common prior art method of distributing marketing information to consumers involves the use of traditional direct mail to distribute information in a printed format to solicit a response from an individual. This method involves the printing of paper, envelopes, promotional items, magazines and other devices to convey a message from a business desiring a response from the individual. This traditional direct marketing technique relies upon a static message imprinted permanently on the preferred medium and then distributed through mail, displays, handouts, events and other methods that get a printed piece to an individual. Printing of the message typically takes place weeks or even months prior to distribution.

The printed piece may also request the recipient to respond to inquiries on the printed piece. This recipient may then respond to the static message through traditional means such as by visiting a business location, telephone, a reply mailing, or accessing the Internet on a computing apparatus and providing information by taking action to connect to a web site. Data may then be collected and provided to a research firm or entity and, usually manually, input into a database system. This research firm or entity may then analyze the data and provide reports for use in developing marketing and product or service development strategies. These types of reports are commonly delivered weeks or months after the initial distribution of the mailer and often long after the users have provided the data.

Another prior art method involves the use of the Internet and the web to promote products or services to system users and to collect information about or from system users or their computing or other networking apparatus. For example, marketing and other entities have long sought to both (i) advertise to visitors of web sites and (ii) collect information about such visitors when they visit a web site. One prior art manner of collecting information about such a web site visitor involves presenting the web site visitor with not only (i) conventional web site promotional information on a web site page but also (ii) a question form and asking the visitor to enter information into the form. The web site then stores the information to a database when the visitor enters the data.

The desired data cannot be collected in this manner, however, unless the visitor logs onto the Internet, accesses the appropriate portion of the pertinent web site, and then enters the information on the form page provided by the web site. Also, this technique provides the user with the most current marketing or other web-site-provided information only when the user undertakes the effort of accessing the web site and, through the interaction of the user's computer and the web site, download, or “pull,” information from the site, such as a web page. If the user does not log onto the web site and download or pull the site's information, the user does not receive any information from the web site or provide the web site with the opportunity to ask the user for information from the user.

The underlying reason that the Internet user must first access a given web site and take action to pull information from the site is the underlying structure of the Internet. In general, the Internet is not a broadcast medium. That is, the Internet does not generally provide a vehicle for broadcasting or “pushing” information to users in real time unless the user takes action to access and download the information from a web-site. After the user has accessed and thereby downloaded or pulled a web page and information associated with it from the web site, the website provider usually has no ability to provide updated information to the user through the web site unless the user, or the user's computing apparatus, initiates yet another pull, such as by initiating a “refresh” command when the user is visiting the web site.

The web site provider could send additional updated information to the user by e-mail if the web site provider knows the user's e-mail address. In this case, however, not only must the web site provider know the user's e-mail address, but also the user or the user's computing apparatus must take action upon receipt of the e-mail to access the e-mail message, take action pursuant to the message contents, and again access the site through the user's e-mail system to again pull more content from the web-site provider's web site.

It should be noted that many entities and systems have been developed to try to develop and deploy “push” or real time broadcasting systems through or in connection with the Internet. One prior art technique is called “multicasting.” Multicasting does not involve the common “TCP/IP” two-way information transmission techniques on which the Internet was built, and as a result, in a multicast Internet or similar network, information can be broadcast, or pushed, to users in real time. The Internet and many private networks, however, are generally not multicast enabled for a variety of reasons, including substantial cost of upgrading the routers to include true multicast functionality. Massive numbers, and perhaps most members of the public, cannot be reached by their existing connections to the Internet. Multicasting therefore does not provide a broadbased solution for reaching much, and probably most, of the public.

Even if multicasting were to become a more prominent and ubiquitous technique for content distribution through the Internet or other private networks, it still would not be a panacea for distribution, much less collection, of marketing or other information, including multimedia content, to consumers and others. One reason this is so is because the information cannot be delivered to a user by multicasting unless the user has logged onto a particular network and taken action to access a multicast channel. Just as a television viewer will not receive a television broadcast if the viewer has not turned on a television and tuned into the channel providing the broadcast, so too with the multicasting. All users must log-in and access a multicast channel in order to receive it (again, assuming that the intervening networks are multicast enabled).

One popular marketing and information collection system that can reach users without having them assess a web-site, television channel, or multicast on the Internet utilizes CD-ROM or DVD digital storage media, which are physically delivered to users by a physical delivery service, such as by government mail or a commercial delivery service. A user to whom the CD or DVD is delivered may then, if the user so chooses, load the CD-ROM or DVD into a computing device, and the CD-ROM or DVD may then play on the user's machine, often automatically upon being loaded into the user's machine.

These types of multimedia physical delivery techniques also often include an autoloader program on the delivered CD or DVD. When the receiving user loads and runs the CD or DVD, the autoloader program automatically loads into the user's computer, or activates a program on the user's computer, in order to present a form screen to the user. The user may then enter information into the form, print it, and mail or fax the form to the supplier of the multimedia or other entity identified by the program or form.

These prior art physical delivery techniques, however, typically involve a substantial delay between when the marketer or other content provider sends the CD or DVD to the user and when the user receives the CD or DVD from a delivery service. In addition, the user may then delay loading and running the CD or DVD for some time—long after the information is most current and worthwhile to the information provider or the user. As a result, these types of physical delivery techniques often provide the user with outdated or at least less than fully up-to-date information; and in any event, the information they do provide is usually not alterable once burned onto the CD or DVD and sent to the user.

With regard to data collection from the user, the above types of technologies require the user to engage in substantial effort to provide the desired data, such as by printing out a data collection form and then mailing or faxing it or even by attaching the information to an e-mail message and sending the message by e-mail. Many users will not go to such lengths to provide the desired data, and even when provided by the user, the entity that receives the data must then extract it from the physical form provided by the user and record the data in a database.

### BRIEF SUMMARY OF ASPECTS OF THE INVENTION

In one aspect, the present invention provides a system and method for distribution of updated multimedia content to computing equipment users. The multimedia content distribution system preferably provides a computing equipment user with an information storage device containing multimedia content that the user may recover from the information storage device. When the user accesses the information storage device through computing equipment, the user not only may access multimedia content on the information storage device but also may be automatically linked to a remote server system that supplements or alters the multimedia content provided by the information storage device.

In another aspect, the present invention may provide a system and method for collecting information from computing equipment users. Preferably, the information storage device also includes a command or program that automatically causes a query of the user or the user's machine for desired data and automatically forwards that data to a remote data collection server or service. In one preferred embodiment, the program automatically loads a questionnaire for the user to answer, and then automatically transmits the answers entered by the user to a remote data collection system that may run in conjunction with a web-site or other content server that provides updated multimedia content to the user.

In a preferred embodiment, the information storage device consists of a CD or DVD. The information device may, however, consist of one or more other storage devices that can deliver multimedia content to a computing equipment user.

Accordingly, the present invention can, if desired, provide a method of automatically updating information contained on a storage device. If the computing equipment user decides to respond to the questionnaire, the responses to the questionnaire preferably are forwarded to, and sorted at, the remote server location according to specific recordset criteria usually through some kind of a database. This allows the receiver of the user's information to receive information specific to his needs.

In one preferred information collection system and method, the questionnaire prompts the user for information, collects this information, stores it in a database and then based on the information collected delivers a new question or unique content tailored to the user.

The preferred information collection system and method also may include a data collection server and database system. Most preferably, the server has a connection to a local area network such as an office network or a wide area network such as the Internet. Most preferably, the database system is a relational database system, sends and receives information over a network of computers and is designed to logically sort and store the information.

One preferred multimedia distribution system provides the advantage of not only ensuring a computing equipment user is provided with multimedia information even if the user does not take action to procure the multimedia information, such as by logging into a web site for example, but also helps ensure that the computing user can receive altered or additional multimedia information when the user accesses the multimedia information delivered to the user.

A further advantage of the preferred multimedia distribution system is that it can provide automated collection and sending of information from the user's computer to a remote server.

It is also advantageous to provide a system and method for updating information received by a user so that the user is aware of changes that might affect decisions being made by a user. For instance, if a user is responding to a website form with information that is out-dated or invalid, the user may provide improper responses. However, the present invention provides the advantage of giving the user the most up-to-date information with which to make a decision.

Most preferably, the present invention may provide a system and method for distributing marketing information and collecting marketing information. It may therefore provide a marketing business method, for which a marketing business may charge a fee for use of the method or for providing the method as a service to third party product or service providers.

The preferred system and method can distribute multimedia marketing information about a product or service via a multimedia storage device, such as a CD, DVD, or other transportable storage media, provide automated updating or addition to the multimedia information on a user's computing apparatus when the user accesses the multimedia from the storage device, and also provide automated collection of marketing or other data from the user or its machine for automated forwarding of the information to a remote database collection and processing system. The system and method can thus help provide the most current or desired type of multimedia marketing information to consumers or users without requiring them to have to necessarily take action to log into a web site and download the information either to procure it in the first instance or to procure updated or additional information at run time.

It is to be understood that the foregoing brief summary of disparate aspects of the invention does not mean that every embodiment of the present invention must include all such aspects or provide all such advantages. Rather, the scope of the present invention is to be determined by the scope of the claims as issued.

In addition, it is also to be understood that there are other inventive aspects and advantages of the preferred embodiments. They will become apparent as the specification proceeds.

### BRIEF DESCRIPTION OF THE DRAWINGS

FIG. 1 illustrates the basic information flow from a user, through a PC and a network and into a server.

FIG. 2 illustrates a variable position holder, which responds to a user click on text to gather current prize information from a remote server for display in the CD-ROM or DVD program.

FIG. 3 illustrates another user screen in which information obtained from a server is displayed to a user.

FIG. 4 illustrates a typical flow chart for the program contained on a storage medium.

FIG. 5 illustrates the basic information flow from the user and the user's storage device, through the PC and the network and into the server.

FIG. 6 illustrates a sample overall view of the disclosed system.

FIG. 7 illustrates an example of the disclosed system in use.

FIG. 8 illustrates an example of a visual process flowchart;

FIG. 9 illustrates a user screen showing variable data input field.

FIG. 10 further illustrates a user screen showing a variable data field.

FIG. 11 further illustrates a user screen showing a variable data field.

FIG. 12 further illustrates a user screen showing a variable data field.

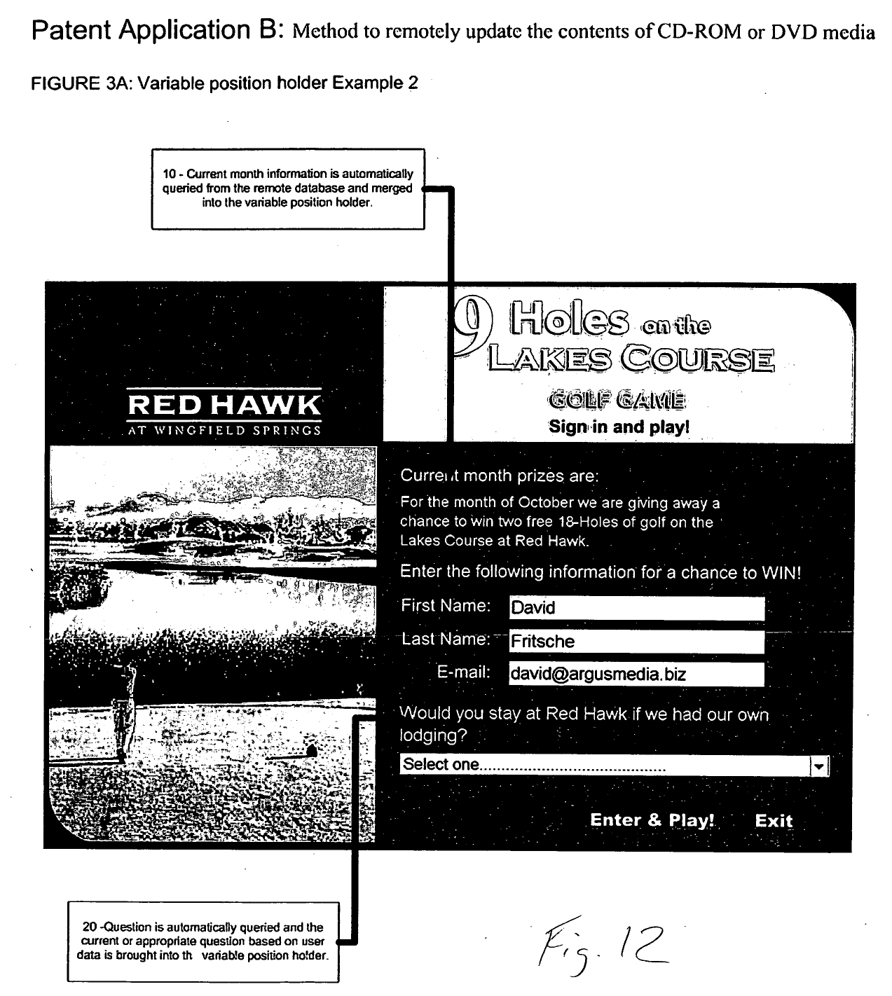

FIG. 13 further illustrates a user screen showing a variable data field.

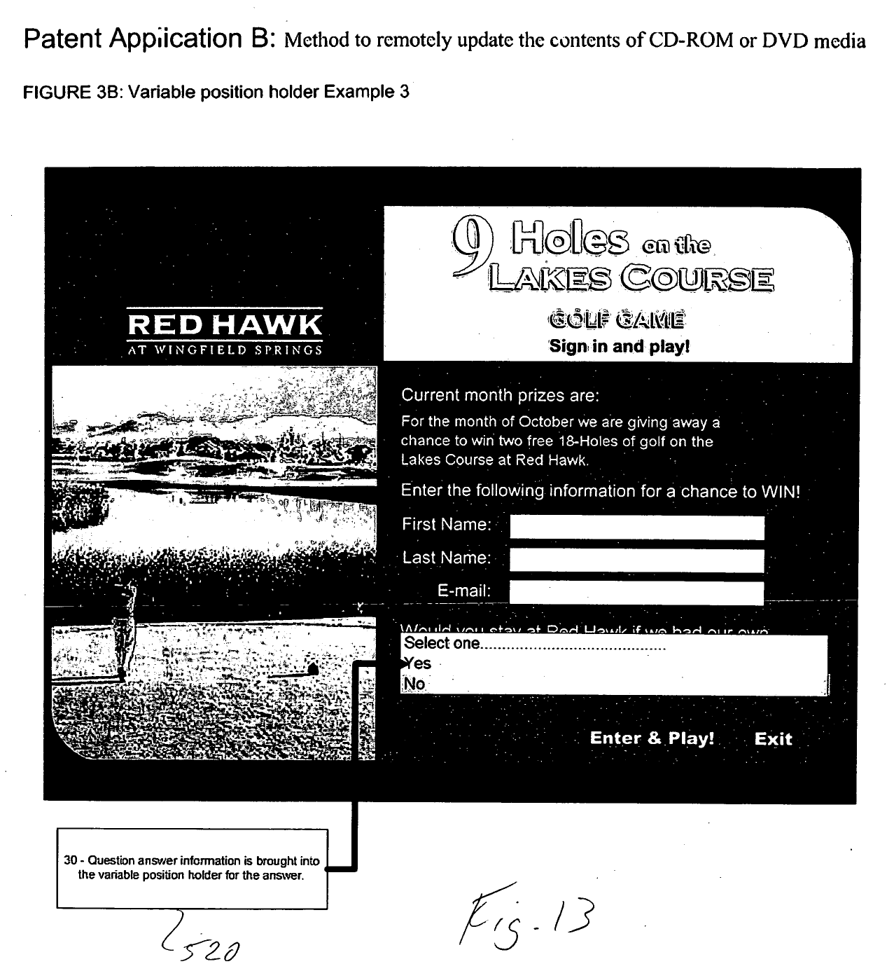

### DETAILED DESCRIPTION OF THE PREFERRED EMBODIMENTS

The systems and methods described herein are implemented as logical operations in a distributed processing system comprised of a client computer, information storage media and associated multimedia content and autoloader programs, a server computing system, and an automated multimedia distribution and database information collection system running on the server system.

The logical operations take place as a series of programmed steps that instruct a program contained within the storage device to prompt a server program to provide information to a remote user when the remote user loads the information storage media into the users computing machine, and logical steps to transfer this information to variable position holders on the storage device across a network computing system. The logical operations also take place as a series of programmed steps that instruct a program contained on the storage device to prompt the computer user to provide information and the logical steps to transfer this information to a storage media across a network computing system. In existing systems, these steps are indirect and require extra steps from the user. This system both streamlines the afore-mentioned process and allows static storage devices to become dynamic.

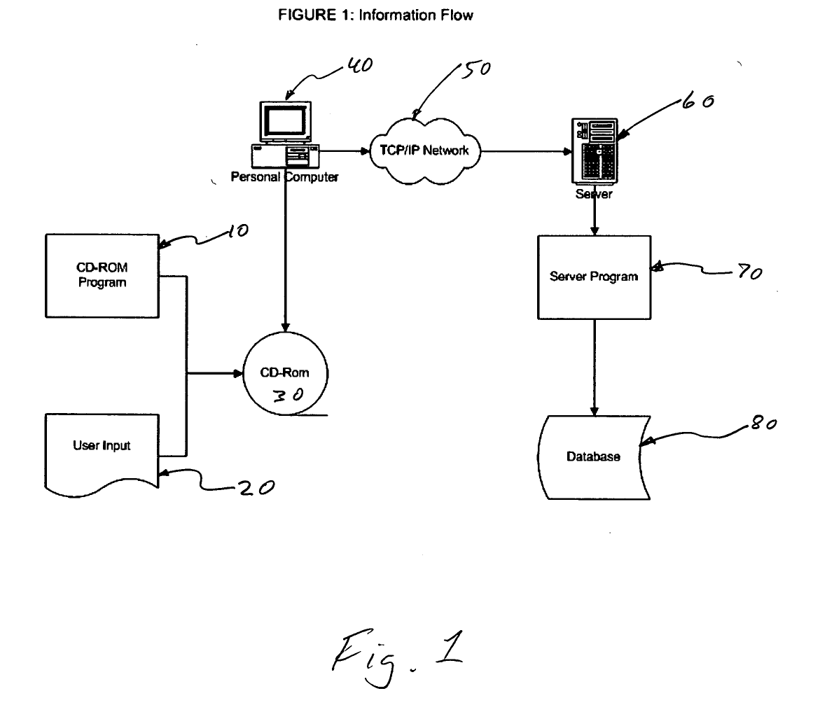

With reference to FIG. 1, steps of an embodiment of the disclosed method are depicted in flow chart form. A program (10) is written in a standard programming language and is stored on a CD-ROM, DVD or other storage device (30). The programming language can be any language that can gather input from a user such as C++, Visual Basic, Pascal, FoxPro, COBOL, FORTRAN, Lingo, etc. The program (10) allows for variable data to be placed seamlessly and without the attention of the user into the program (10) by a server at a remote location. This variable position holder allows for text, graphics, audio, video or any other digital data to be placed therein. This information could be as simple as a character of text or as complex as video data.

In the process of using the program (10), the user interacts with the program (10) by providing user input (20). Again, input (20) can be textual, graphical, audio, video, or other digital input. As program (10) is operated and when a variable position holder is encountered, a request is made to a remote server (60) through a network (50) for the most current data. If the server can serve the request, the current information is placed into the variable. Typically, if the current content is not available for any reason, default content is placed from the local media source into the variable. The program (10) temporarily stores the information in a series of variables. A string is created which contains an information query. The information query is specific information that identifies the program being run, the storage device (30) on which the program is being run, and the URL of the user's computer. These variables are passed without the user's knowledge through the network to the remote server (60) at a predetermined URL. The remote server (60) classifies the information contained in the string according to information collected such as information inserted by the user; the remote IP address of the user's computer (40) and standard Internet visit logic to determine where to store the information and its uniqueness in the database.

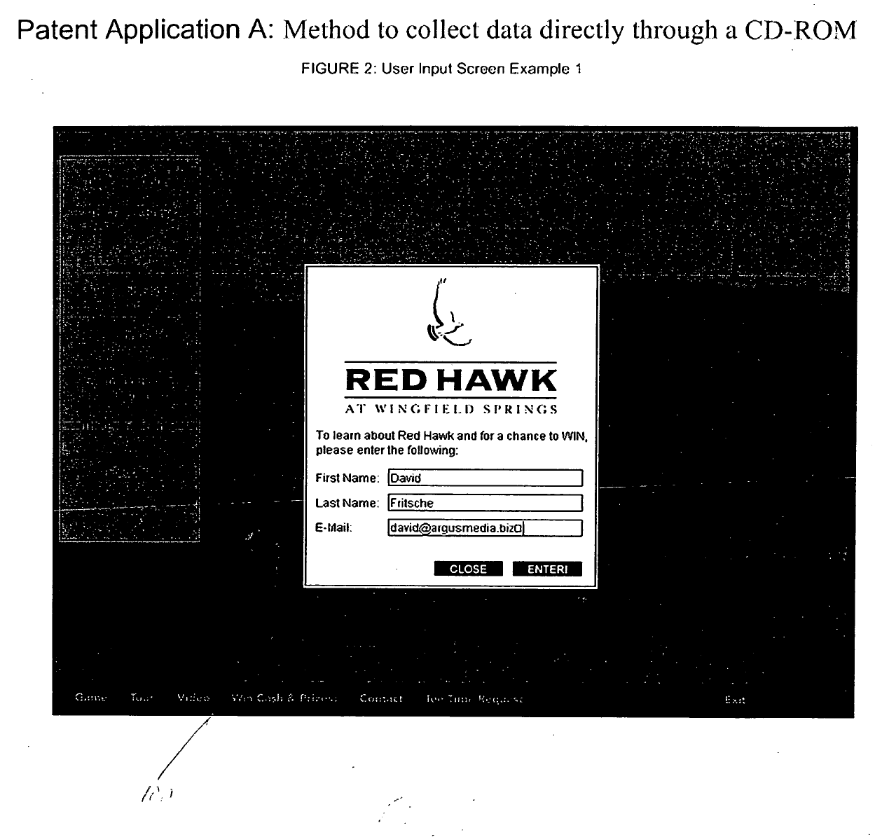

With reference to FIG. 2, to collect the information from the user, this method requires the use of a data collection form (100). Upon being prompted by the program, the user enters information into the program contained on the CD-ROM, DVD or other storage device such as text, pictures, audio or video. This information is passed directly to a preprogrammed database through a network using TCP/IP and the appropriate Universal Resource Locator (URL). The information is then stored in a predefined database at the URL location.

The user input 20 is collected from the user and the storage device 30 and transferred through the network 50 in the form of IP packets. The packets are routed to the URL specified in advance by the program (10). The URL is resolved to an IP address and the packets are transferred to this server location (60). When the server (60) takes control of the packets, they are reassembled into the information transferred through the standard OS TCP/IP protocol. A program on the server determines the appropriate action for the information. These IP packets are routed via port “eighty” (not shown). This is necessary to avoid unnecessary blockage from firewalls and is not in violation of any security protocols since the information is treated as any other standard internet port “eighty” communication and would be filtered according to the standard rules established by the firewall administrators. The server program (70) can be written in any language that can read the incoming information to the server. The information is validated according to predetermined rules and stored if the rules are satisfied.

A response is generated and sent back to the user. The user's URL information was collected from the user string that was passed to the remote server (60) earlier. This response is placed into a string. The string is separated into IP packets and sent through the same TCP/IP network to the user URL. The program reads the information passed and places the information seamlessly and without the user's knowledge into the CD-ROM, DVD or other storage device (30) at the specified variable position holder from which the request was made.

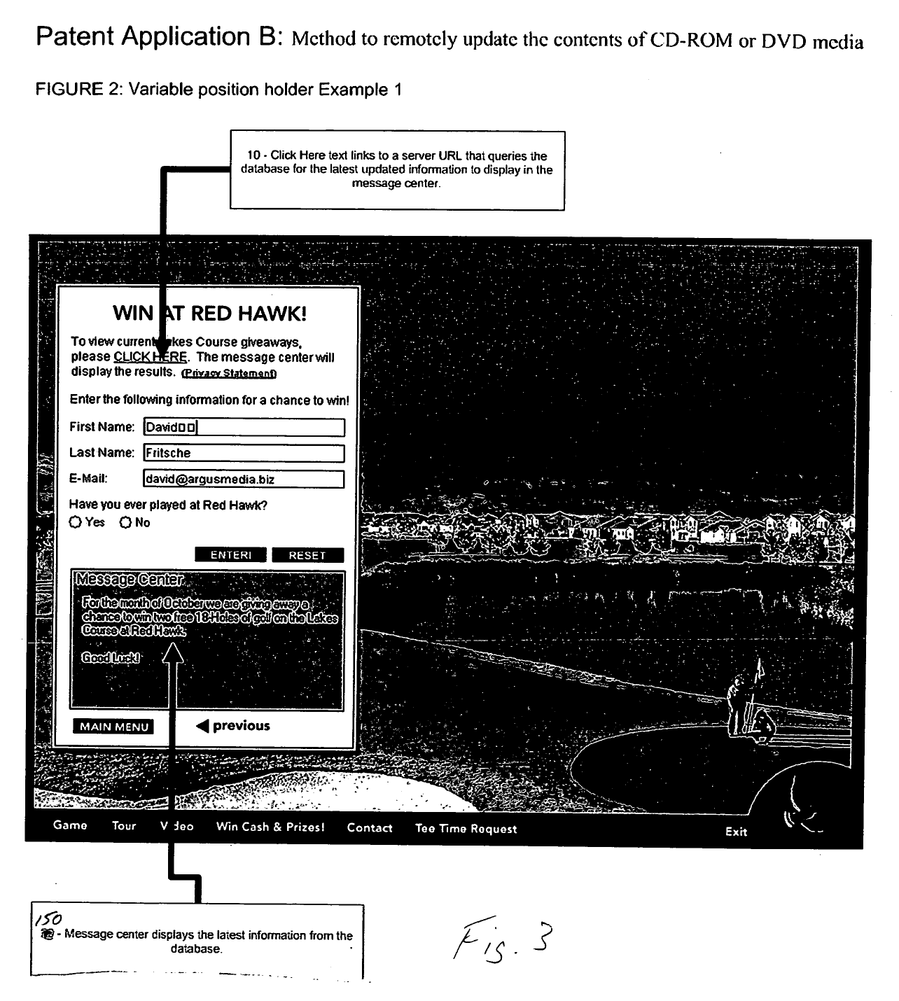

With respect to FIG. 3, the user screens are now updated with current information (150) directly from the remote server. At this point, the information transfer is complete and we have achieved our goal of remotely updating the storage device content.

By way of example, the contents of the system are as follows:

1) A personal computer (40) with a standard CD-ROM or DVD drive and keyboard. This computer typically is running either Microsoft's Windows™ 95 operating system or higher or Apple's Macintosh™ operating system version 8 or higher. The type of computer (processor, memory, storage capacity and operating system is immaterial except that it should be able to read a standard encoded CD-ROM or DVD built for Windows™ or Mac OS™. The personal computer should be setup to allow for the TCP/IP protocol to run. This Internet Protocol (IP) is standard with the operating systems mentioned. The personal computer may have a display device such as a monitor or projection device that allows for program output to be displayed to the user.

2) A network (50) can be a Local Area Network (LAN) such as an office or workgroup network, a Virtual Private Network (VPN), or a Wide Area Network (WAN) such as the public Internet.

3) This same network (50) should be connected to a server (60). The server (60) can be another personal computer (not shown) or a dedicated server. The server should at least be able to communicate using the TCP/IP protocol and should be connected to the same network as the personal computer. It may be running any version of UNIX, Windows, MAC OS, MVS or other operating system. The server's operating system, memory, storage requirements and other devices are immaterial as long as it can communicate through TCP/IP and store information in some retrievable format. The most likely configuration of the server (60) is as a web server using any of the standard web server software such as Microsoft's Internet Information Server.

4) A CD-ROM or DVD program (10) designed with variable position holders on the CD-ROM or DVD and to pass this variable position to the server (60) through the network (50).

5) A user to provide user input (20), run the CD-ROM or DVD program (10) and to interact with the contents of the CD-ROM or DVD program (10).

6) A server program (70) designed to receive the information from the CD-ROM or DVD program (10), validate the information, store it as appropriate to its predetermined rules and to pass the appropriate information through the network 50 and into the variable position holders.

7) A structured storage medium (80) on the server computer such as a standard database or file system. The storage medium (80) can be any standard database such as Oracle, SQL Server or DB2, and is typically communicated with through a protocol-provisioning layer such as the industry standard ODBC (Open DataBase Connectivity) protocol.

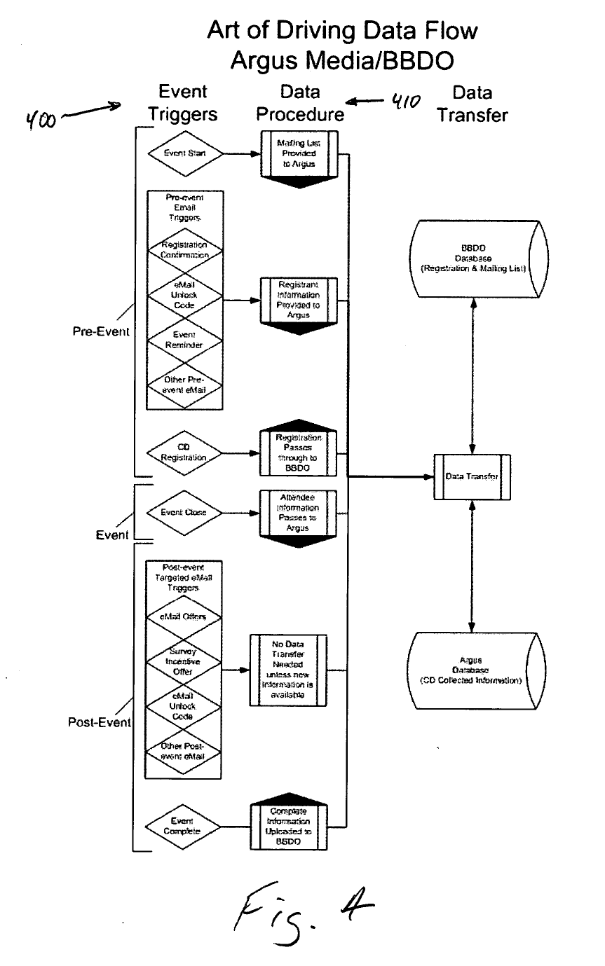

FIG. 4 shows a typical flow chart for the program 10 contained on the storage medium 30. At periodic points during a marketing campaign, FIG. 4 illustrates the updating of a customer's remote database with the content collected during the campaign through this unique system. Typically, there is a menu system that guides the users through the content. A program 10 creates and manages the content to allow the user to easily navigate or auto-navigate through the content. At various points in the program data is sent and received from the server. “Event Triggers” 400 cause the transfer of information across network 50. The type of information being passed is represented in data procedure step 410. The information is passed to database 80 during the data transfer step 420. Prior to an event, a CD-ROM is sent to a user as an invitation to the event. By way of example, the user signs up for an event such as an auto-show or other event through the program on the storage device 10. The server 60 sends a code back to the storage device 10 unlocking additional content on the storage device 10. The server 60 also sends an email confirmation to the user. The program 10 acts at various points of an event such as an auto-show or other events to communicate content to a user.

Examples of code contained on storage device 30 are provided below:

### EXAMPLE #1

This section of code is an example of a means to collect an answer to a question along with name and email information and to then send that information to the server.

```
global gStatus, gNetID, gFormPropLst, gInternetStatus, gLastStatusUpdate
global gTransactionStartTime, gPopInputPropLst, gPopFieldPropLst
on SubmitInfo aWhichForm
  case aWhichForm of
    #LakesCourse:
      qID = 21
      aID = RtrnLakesCourseQ ( )
    #JuniorGolf:
      qID = 17
      aID = RtrnJuniorGolfQ ( )
    #Freddies:
      qID = 22
      aID = RtrnFreddiesQ ( )
    #GolfAcademy:
      qID = 25
      aID = RtrnGolfAcademyQ ( )
  end case
  InitServerTransaction
  BaseURL = “http://redhawk.argusmedia.biz/surveyrecord.asp”
  FirstNameTxt = member (“First Name”, “scripts”).text
  LastNameTxt = member (“Last Name”, “scripts”).text
  EMailTxt = member (“E-Mail”, “scripts”).text
  gNetID = getNetText (BaseURL, [#fnm:FirstNameTxt, #lnm:LastNameTxt, #email:EMailTxt,
#question_id: qID, #answer_id:aID])
end
on InitServerTransaction
  gLastStatusUpdate = the milliseconds
  gTransactionStartTime = the milliseconds
  member (“Results Field”).text = “Contacting Server...”
  gStatus = #WaitingForServer
end
```

### EXAMPLE #2

This example shows a section of code that updates the variable with content it receives from the server.

```
on CheckPrize aWhichForm
  baseURL = “http://redhawk.argusmedia.biz/sectionprize.asp”
  case aWhichForm of
    #LakesCourse: qID = 21
    #GolfAcademy: qID = 25
    #JuniorGolf: qID = 17
    #Freddies: qID = 22
  end case
  gNetID = getNetText (BaseURL, [#question_id: qID])
  InitServerTransaction
end
on FrameCheck
  case gStatus of
    #WaitingForServer:
      if netDone (gNetID) then
        put “netTextResult (gNetID):” && netTextResult (gNetID)
        gStatus = #Idle
        if neterror (gNetID) = “OK” then
          member (“Results Field”).text = netTextResult (gNetID)
        else
          ErrorMessage = ReturnNetErrorString (gNetID)
          member (“Results Field”).text = “ERROR:” && ErrorMessage & RETURN & “Plese
make sure that you are connected to the Internet and try again.”
        end if
      else
        TransactionAge = the milliseconds − gTransactionStartTime
        if(the milliseconds − gLastStatusUpdate) > 2000 then
```

### EXAMPLE #3

This example shows the gathering and sending of information through the network connection.

```
if TransactionAge < 60000 then
        NewText = member (“Results Field”).text & “.”
        member (“Results Field”).text = NewText
            --put “setting status field to:” && NewText
          else
            --GIVE a 60 second time out notice
            gInternetStatus = (the environment).internetConnected
            case gInternetStatus of
              #online:
                ErrorMsg = “WARNING: The server may not be responding. Please try sending the
information again in a few minutes.”
                member (“Results Field”).text = line 1 of member (“Results Field”).text & RETURN &
ErrorMsg
              #offline:
                ErrorMsg = “WARNING: Unable to detect an active Internet connection. \
Please connect to the Internet, then try sending the information again.”
            end case
          end if
          gLastStatusUpdate = the milliseconds
        end if
      end if
  end case
end
on InitFormRoutines
  gFormPropLst = [#fnm: “First Name”, #lnm: “Last Name”, #email: “E-Mail”]
  gStatus = #Idle
  ClearForm
  gInternetStatus = (the environment).internetConnected
  case gInternetStatus of
    #online: member (“Results Field”).text = “”
    #offline:
      ErrorMsg = “WARNING: Unable to detect an active Internet connection. \
You must be connected to the Internet before sending the information in this form.”
      member (“Results Field”).text = ErrorMsg
  end case
  InitPopMenuVaridables
end
```

### EXAMPLE #4

This section of code shows an example of a question presented to the user.

```
on InitPopMenuVaridables
  gPopInputPropLst = [#GolfAcademy: 1, #Freddies: 1]
  gPopFieldPropLst = [#GolfAcademy: “Golf Academy Pop Menu”, #Freddies: “Freddies Pop
Menu”]
  end
on stopMovie
  ClearForm
end
on RtrnLakesCourseQ
  if member(“CheckBox No”, “scripts”).hilite then return 82--“No”
  else if member(“CheckBox Yes”, “scripts”).hilite then return 81 --“Yes”
  else return “0”
end
on RtrnJuniorGolfQ
  if member(“CheckBox No JG”, “scripts”).hilite then return 70 --“No”
  else if member(“CheckBox Yes JG”, “scripts”).hilite then return 69 --“Yes”
  else return “0”
end
on RtrnGolfAcademyQ
  SelectedLine = getaProp (gPopInputPropLst, #GolfAcademy)
  case SelectedLine of
    1: return 0 --none set
    2: return 87 --My putting
    3: return 88 --My drives
    4: return 89 --My chipping
    5: return 90 --My clubs
    6: return 91 --My clothes
  end case
end
on RtrnFreddiesQ
  SelectedLine = getaProp (gPopInputPropLst, #Freddies)
  case SelectedLine of
    1: return 0 --none set
    2: return 83 --family
    3: return 84 --business associates
    4: return 85 --pick up rounds
    5: return 86 --Do not play
  end case
end
```

### EXAMPLE #5

This section of code shows one way of determining the connection to the Internet and variable responses to the user based on the connection status. This status determines the ability of the program to update content.

```
on NewPopMenuInput aFormID, aLine
  setProp (gPopInputPropLst, aFormID, aLine)
  put “PopMenu updated:” && gPopInputPropLst
end
on ClearForm
  member (“Results Field”).text = “”
  member(“CheckBox No”, “scripts”).hilite = 0
  member(“CheckBox Yes”, “scripts”).hilite = 0
  member(“CheckBox No JG”, “scripts”).hilite = 0
  member(“CheckBox Yes JG”, “scripts”).hilite = 0
  member(“First Name”, “scripts”).text = “”
  member(“Last Name”, “scripts”).text = “”
  member(“E-Mail”, “scripts”).text = “”
  gStatus = #Idle
  InitPopMenuVaridables
  if the frame > 30 then go loop
end
on ReturnNetErrorString aNetID
  case netError (aNetID) of
    4: return “Bad MOA class. The required network or nonnetwork Xtras are improperly installed
or not installed at all.”
    5: return “Bad MOA Interface. See 4.”
    6: return “Bad URL or Bad MOA class. The required network or nonnetwork Xtras are
improperly installed or not installed at all.”
    20: return “Internal error. Returned by netError( ) in the Netscape browser if the browser
detected a network or internal error.”
    4146: return “Connection could not be established with the remote host.”
    4149: return “Data supplied by the server was in an unexpected format.”
    4150: return “Unexpected early closing of connection.”
    4154: return “Operation could not be completed due to timeout.”
    4155: return “Not enough memory available to complete the transaction.”
    4156: return “Protocol reply to request indicates an error in the reply.”
    4157: return “Transaction failed to be authenticated.”
    4159: return “Invalid URL.”
    4164: return “Could not create a socket.”
    4165: return “Requested object could not be found (URL may be incorrect).”
    4166: return “Generic proxy failure.”
    4167: return “Transfer was intentionally interrupted by client.”
    4242: return “Download stopped by netAbort(url).”
    4836: return “Download stopped for an unknown reason, possibly a network error, or the
download was abandoned.”
  end case
end
```

Examples of server code are provided below:

### EXAMPLE #1

This section of code shows one way to receive content from the storage device and determine the identity of the user through interaction with the database.

```
<%@LANGUAGE=“VBSCRIPT”%>
<!--#include file=“Connefctions/connargustest.asp” -->
<%
ccampaign_id=22
ipaddress=request.servervariables(“remote_addr”)
set Recordset2 = Server.CreateObject(“ADODB.Recordset”)
Recordset2.ActiveConnection = MM_connargustest_STRING
    Recordset2.Source = “SELECT respondent_id FROM respondent WHERE
campaign_id=” & ccampaign_id & “ and remote_addr=”‘ & ipaddress & ’“ and datediff(mi,
date_modified, getdate( )) <=20”
    Recordset2.CursorType = 0
    Recordset2.CursorLocation = 2
    Recordset2.LockType = 3
    Recordset2.Open( )
    if not recordset2.eof then
        nrespondent_id=recordset2.fields.item(“respondent_id”).value
    else
        nrespondent_id=0
    end if
```

### EXAMPLE #2

This example code shows an insertion of a new identity into a database.

```
if nrespondent_id=0 then
        Recordset2.close( )
        Recordset2.Source = “select mid=max(respondent_id) from respondent”
        Recordset2.Open( )
        cmid=(recordset2.fields.item(“mid”).value) + 1
        Recordset2.close( )
        Recordset2.Source = “set identity_insert respondent on insert into respondent”
        recordset2.source = recordset2.source & “(respondent_id, campaign_id, ”
        recordset2.source = recordset2.source & “date_modified, date_created,
remote_addr, distribution_code, email) ”
        recordset2.source = recordset2.source & “ values (” & cmid & “,” &
ccampaign_id & “,”
        recordset2.source = recordset2.source & “getdate( ), getdate( ),”‘
        recordset2.source = recordset2.source & ipaddress & ’“, ‘golfgame’,”)”
        recordset2.source = recordset2.source & “set identity_insert respondent off”
        Recordset2.Open( )
        nrespondent_id=cmid
    end if
```

### EXAMPLE #3

This example shows code for the selection of question content and the returning of this variable content to the user's storage device program.

```
set Recordset1 = Server.CreateObject(“ADODB.Recordset”)
Recordset1.ActiveConnection = MM_connargustest_STRING
Recordset1.Source = “select q.question, q.question_id, a.answer, a.answer_id from question q,
answer a, campaign_question cq where q.question_id=a.question_id and
cq.question_id=q.question_id and cq.main_question=‘Y’ and cq.campaign_id=” & ccampaign_id
& “order by a.sortorder”
rem response.write Recordset1.Source
Recordset1.CursorType = 0
Recordset1.CursorLocation = 2
Recordset1.LockType = 3
Recordset1.Open( )
Recordset1_numRows = 0
cstring=“”
cstring=“question=” + replace(recordset1.fields.item(“question”).value,“ ”,“+”) &
“&question_id=” & cstr(recordset1.fields.item(“question_id”).value)
i=0
while not recordset1.eof
    i=i+1
    cstring=cstring + “&answer” + cstr(i) + “=” +
replace(recordset1.fields.item(“answer”).value,“ ”,“+”)+ “&answer_id” + cstr(i) + “=” +
cstr(recordset1.fields.item(“answer_id”).value)
    recordset1.movenext( )
wend
cstring=“noanswers” + cstr(i) + “&” + cstring
response.write cstring
%>
```

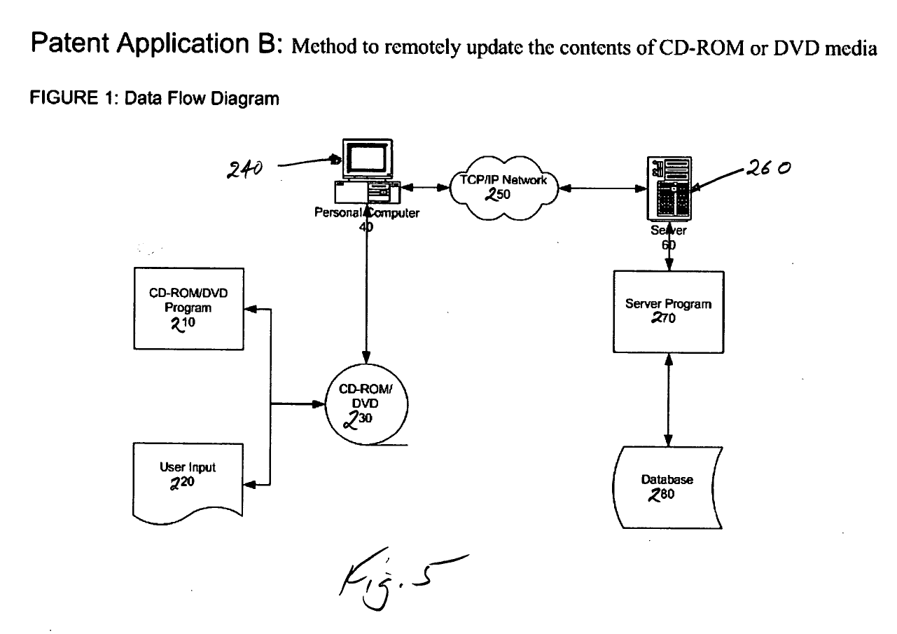

With reference to FIG. 5, the steps of a further embodiment are depicted in flow chart form. The program (510) is written in a standard programming language. The language can be any language that can gather input from a user such as C++, Visual Basic, Pascal, FoxPro, COBOL, FORTRAN, Lingo, etc. Program (510) prompts the user for information. This information can be as simple as a character of text or a pointer to a file located on the user's personal computer. The program temporarily stores the inputted information in a series of variables. These variables are passed without the user's knowledge through a network (550) to the server (560) at a predetermined URL. The server (560) classifies the information according to its uniqueness such as the inputted information, the remote IP address of the computer and standard Internet visit logic to determine where to store the information.

The information transferred may be collected through prompts to the user to enter information with the keyboard and/or mouse. The information may be in the form of a binary file such as an audio file, video or picture file. The information may also be collected without user input. In this way, key information stored on the storage device may be used to identify the storage device to the server database (580).

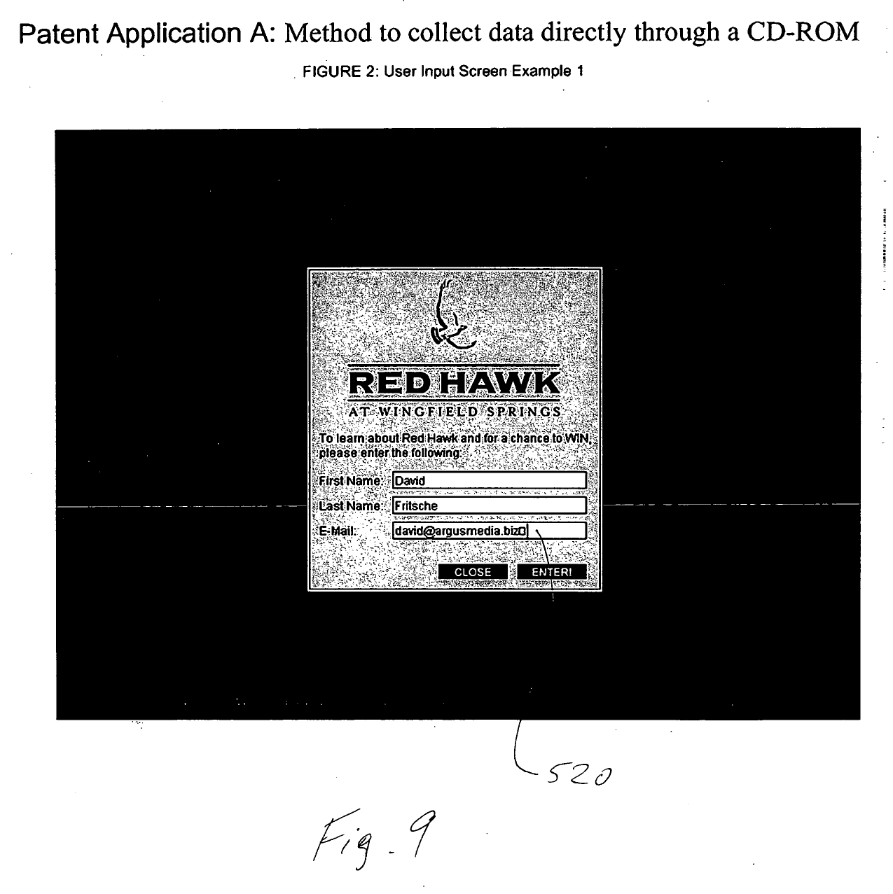

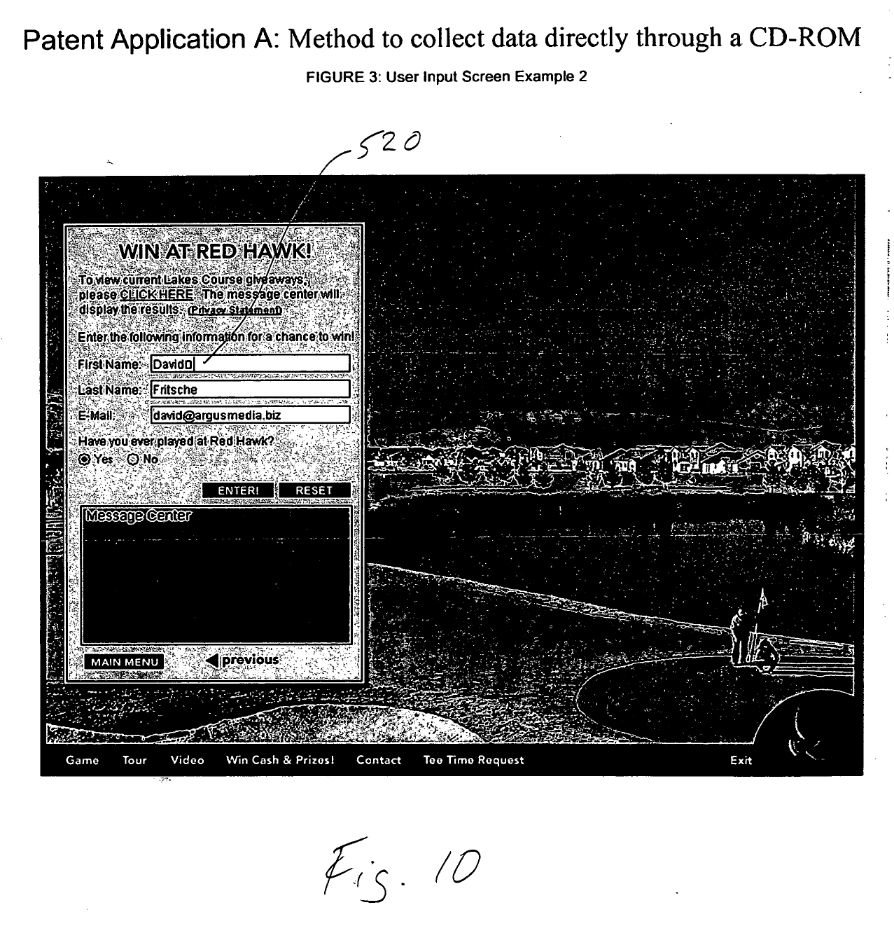

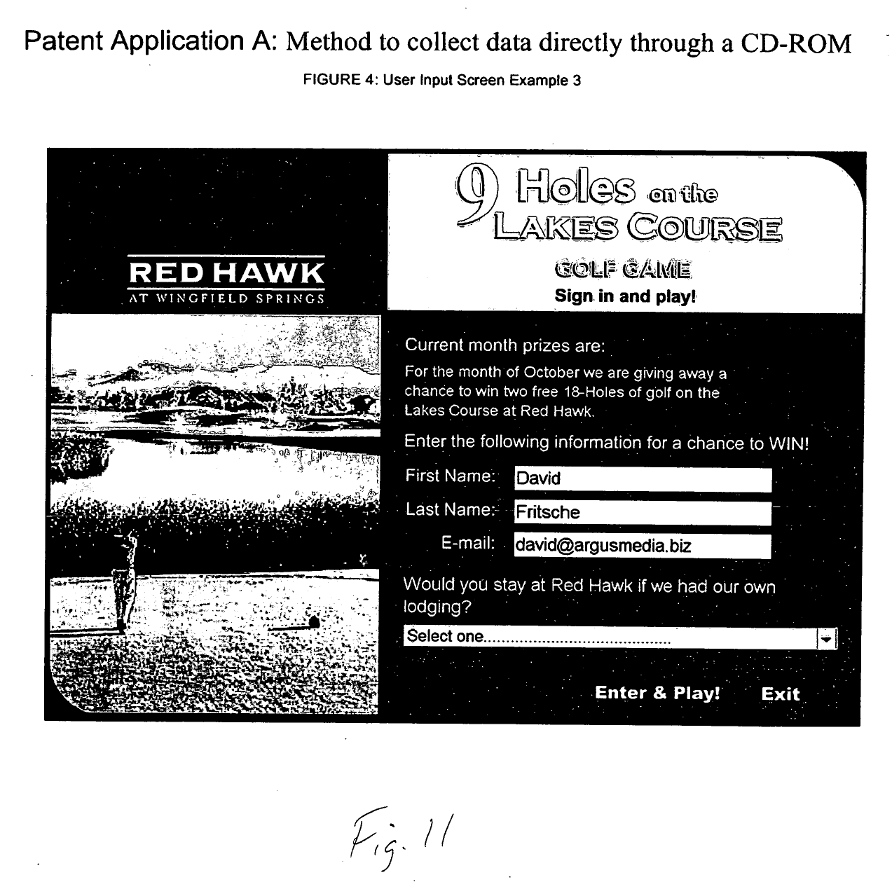

With reference to FIGS. 5, 9, 10, 11 12 and 13, the information is collected from the user input (520) and the storage device and transferred through the network in the form of IP packets. The packets are routed to the URL specified in advance by the program (510). The URL is resolved through a typical Domain Name Server to an IP address and the packets are transferred to this server location. When the server takes control of the packets, they are reassembled using the standard OS TCP/IP protocol. A program on the server determines the appropriate action for the information. These IP packets are routed via port “eighty” (not shown). This is necessary to avoid unnecessary blockage from corporate and other firewalls and is not in violation of any security protocols since the information is treated as any other standard port communication and would be filtered according to the standard rules established by the firewall administrators.

The server program (570) can be written in any language that can read the incoming information to the server. The information is validated according to predetermined rules and stored if the rules are satisfied. A predetermined rule is intended to validate content such as an email address. An invalid email address would not be stored and the user would be prompted to correct. A response is generated and sent back to the storage device (530) to be integrated with its programming.

At this point, the information transfer is complete and we have achieved our goal of transferring information directly from the CD-ROM, DVD or other storage device and the user into our database waiting on the server.

By way of example, the contents of the system are as follows:

1) A personal computer (540) with a standard CD-ROM or DVD drive and keyboard. This computer typically is running either Microsoft's Windows™ 95 operating system or higher or Apple's Macintosh™ operating system version 8 or higher. The type of computer (processor, memory, storage capacity and operating system) is immaterial except that it should have the ability to read a standard encoded CD-ROM or DVD built for Windows™ or Mac OS™. The personal computer should be setup to allow for the TCP/IP protocol to run. This Internet Protocol (IP) is standard with the operating systems mentioned. The personal computer should have a display device such as a monitor or projection device that displays program output to the user.

This personal computer should have a temporary or permanent link to a network running the TCP/IP protocol. This link can be through a dial-up modem, through a network card or other typical devices that allow the personal computer to communicate over a network (550).

2) The network (550) can be a Local Area Network (LAN) such as an office or workgroup network, a Virtual Private Network (VPN) or a Wide Area Network (WAN) such as the public Internet.

3) This same network should be connected to a server (560). The server (560) can be another personal computer or a dedicated server. The server should at least be able to communicate using the TCP/IP protocol and should be connected to the same network as the personal computer (540). It may be running any version of LNIX, Windows, MAC OS, MVS or other operating system. The server's operating system, memory, storage requirements and other devices are immaterial as long as it can communicate through TCP/IP and store information in some retrievable format. The most likely configuration of the server is as a web server using any of the standard web server software such as Microsoft's Internet Information Server.

4) A CD-ROM or DVD program (510) designed to collect information from the CD-ROM or DVD and the user and to pass this information to the server through the network (550).

5) A user to run the CD-ROM or DVD program in #4 above, and to interact with the contents of the CD-ROM or DVD program (510).

6) A server program designed to receive the information from the CD-ROM or DVD program, validate the information and store it as appropriate to its predetermined rules.

7) A structured storage medium (580) on the server computer such as a standard database or file system. The database can be any standard database such as Oracle, SQL Server or DB2, and is typically communicated with through a protocol-provisioning layer such as the industry standard ODBC (Open DataBase Connectivity) protocol.

Examples of a program contained on the portable storage device are provided below:

### EXAMPLE #1

This section of code is an example of a means to collect an answer to a question along with name and email information and to then send that information to the server.

```
global gStatus, gNetID, gFormPropLst, gInternetStatus, gLastStatusUpdate
global gTransactionStartTime, gPopInputPropLst, gPopFieldPropLst
on SubmitInfo aWhichForm
  case aWhichForm of
    #LakesCourse:
      qID = 21
      aID = RtrnLakesCourseQ ( )
    #JuniorGolf:
      qID = 17
      aID = RtrnJuniorGolfQ ( )
    #Freddies:
      qID = 22
      aID = RtrnFreddiesQ ( )
    #GolfAcademy:
      qID = 25
      aID = RtrnGolfAcademyQ ( )
  end case
  InitServerTransaction
  BaseURL = “http://redhawk.argusmedia.biz/surveyrecord.asp”
  FirstNameTxt = member (“First Name”, “scripts”).text
  LastNameTxt = member (“Last Name”,“scripts”).text
  EMailTxt = member (“E-Mail”, “scripts”).text
  gNetID = getNetText (BaseURL, [#fnm:FirstNameTxt, #lnm:LastNameTxt, #email:EMailTxt,
#question_id: qID, #answer_id:aID])
end
on InitServerTransaction
  gLastStatusUpdate = the milliseconds
  gTransactionStartTime = the milliseconds
  member (“Results Field”).text = “Contacting Server...”
  gStatus = #WaitingForServer
end
on CheckPrize aWhichForm
  baseURL = “http://redhawk.argusmedia.biz/sectionprize.asp”
  case aWhichForm of
    #LakesCourse: qID = 21
    #GolfAcademy: qID = 25
    #JuniorGolf: qID = 17
    #Freddies: qID = 22
  end case
  gNetID = getNetText (BaseURL, [#question_id: qID])
  InitServerTransaction
end
```

### EXAMPLE #2

This example shows a section of code that updates the variable with content it receives from the server.

```
on FrameCheck
  case gStatus of
    #WaitingForServer:
      if netDone (gNetID) then
        put “netTextResult (gNetID):” && netTextResult (gNetID)
        gStatus = #Idle
        if neterror (gNetID) = “OK” then
          member (“Results Field”).text = netTextResult (gNetID)
        else
          ErrorMessage = ReturnNetErrorString (gNetID)
          member (“Results Field”).text = “ERRor:” && ErrorMessage & RETURN & “Please make
sure that you are connected to the internet and try again.”
        end if
      else
        TransactionAge = the milliseconds − gTransactionStartTime
        if (the milliseconds - gLastStatusUpdate) > 2000 then
          if TransactionAge < 60000 then
            NewText = member (“Results Field”).text & “.”
            member (“Results Field”).text = NewText
            --put “setting status field to:” && NewText
          else
            --GIVE a 60 second time out notice
            gInternetStatus = (the environment).internetConnected
            case gInternetStatus of
              #online:
                ErrorMsg = “WARNING: The server may not be responding. Please try sending the
information again in a few minutes.”
                member (“Results Field”).text = line 1 of member (“Results Field”).text & RETURN &
ErrorMsg
              #offline:
                ErrorMsg = “WARNING: Unable to detect an active Internet connection. \
Please connect to the Internet, then try sending the information again.”
            end case
          end if
          gLastStatusUpdate = the milliseconds
        end if
      end if
  end case
end
on InitFormRoutines
  gFormPropLst = [#fnm: “First Name”, #lnm: “Last Name”, #email: “E-Mail”]
  gStatus = #Idle
  ClearForm
  gInternetStatus = (the environment).internetConnected
  case gInternetStatus of
    #online: member (“Results Field”).text = “”
    #offiine:
      ErrorMsg = “WARNING: Unable to detect an active Internet connection. \
You must be connected to the Internet before sending the information in this form.”
      member (“Results Field”).text = ErrorMsg
    end case
  InitPopMenuVariables
end
```

### EXAMPLE #3

This section of code shows an example of a question presented to the user.

```
on InitPopMenuVaridables
    gPopInputPropLst = [#GolfAcademy: 1, #Freddies: 1]
    gPopFieldPropLst = [#GolfAcademy: “Golf Academy Pop Menu”,
    #Freddies: “Freddies Pop
Menu”]
    end
on stopMovie
    ClearForm
end
on RtrnLakesCourseQ
    if member(“CheckBox No”, “scripts”).hilite then return 82--“No”
    else if member(“CheckBox Yes”, “scripts”).hilite then return 81 --
    “Yes”
    else return “0”
end
on RtrnJuniorGolfQ
    if member(“CheckBox No JG”, “scripts”).hilite then return 70 --“No”
    else if member(“CheckBox Yes JG”, “scripts”).hilite then return 69 --
    “Yes”
    else return “0”
end
on RtrnGolfAcademyQ
    SelectedLine = getaProp (gPopInputPropLst, #GolfAcademy)
    case SelectedLine of
        1: return 0 --none set
        2: return 87 --My putting
        3: return 88 --My drives
        4: return 89 --My chipping
        5: return 90 --My clubs
        6: return 91 --My clothes
    end case
end
on RtrnFreddiesQ
    SelectedLine = getaProp (gPopInputPropLst, #Freddies)
    case SelectedLine of
        1: return 0 --none set
        2: return 83 --family
        3: return 84 --business associates
        4: return 85 --pick up rounds
        5: return 86 --Do not play
    end case
end
on NewPopMenuInput aFormID, aLine
    setProp (gPopInputPropLst, aFormID, aLine)
    put “PopMenu updated:” && gPopInputPropLst
end
on ClearForm
    member (“Results Field”).text = “”
    member(“CheckBox No”, “scripts”).hilite = 0
    member(“CheckBox Yes”, “scripts”).hilite = 0
    member(“CheckBox No JG”, “scripts”).hilite = 0
    member(“CheckBox Yes JG”, “scripts”).hilite = 0
    member(“First Name”, “scripts”).text = “”
    member(“Last Name”, “scripts”).text = “”
    member(“E-Mail”, “scripts”).text = “”
    gStatus = #Idle
    InitPopMenuVaridables
    if the frame > 30 then go loop
end
```

### EXAMPLE #4

This section of code shows a variable error string that is returned to the user based on the conditions.

```
on ReturnNetErrorString aNetID
    case netError (aNetID) of
        4: return “Bad MOA class. The required network or nonnetwork Xtras are improperly installed
or not installed at all.”
        5: return “Bad MOA Interface. See 4.”
        6: return “Bad URL or Bad MOA class. The required network or nonnetwork Xtras are
improperly installed or not installed at all.”
        20: return “Internal error. Returned by netError( ) in the Netscape browser if the browser
detected a network or internal error.”
        4146: return “Connection could not be established with the remote host.”
        4149: return “Data supplied by the server was in an unexpected format.”
        4150: return “Unexpected early closing of connection.”
        4154: return “Operation could not be completed due to timeout.”
        4155: return “Not enough memory available to complete the transaction.”
        4156: return “Protocol reply to request indicates an error in the reply.”
        4157: return “Transaction failed to be authenticated.”
        4159: return “Invalid URL.”
        4164: return “Could not create a socket.”
        4165: return “Requested object could not be found (URL may be incorrect).”
        4166: return “Generic proxy failure.”
        4167: return “Transfer was intentionally interrupted by client.”
        4242: return “Download stopped by netAbort(url).”
        4836: return “Download stopped for an unknown reason, possibly a network error, or the
download was abandoned.”
    end case
end
```

Examples of server code are provided below:

### EXAMPLE #1

This section of codes shows the receiving of information from the user by the server and the validation of that information.

```
<%@LANGUAGE=“VBSCRIPT”%>
<!--#include file=“Connections/connargustest.asp” -->
<%
‘set variables
disc_id=request(“disc_id”)
‘response.write disc_id
ccampaign_id=22
cerror=“”
cresponse=“”
bnew=“F”
ipaddress=request.servervariables(“remote_addr”)
‘ error checking
if cstr(request(“answer_id”))=“” then
    nanswer_id=99999
else
    nanswer_id=request(“answer_id”)
end if
if cstr(request(“question_id”))=“” then
    nquestion_id=99999
else
    nquestion_id=request(“question_id”)
end if
if request(“fnm”)<>“” then
    cresponse=cresponse & request(“fnm”) & “ ”
else
    cerror=cerror & “Please enter a first name.” & chr(13)
end if
if request(“lnm”)<>“” then
    cresponse=cresponse & request(“lnm”) & chr(13)
else
    cerror=cerror & “Please enter a last name.” & chr(13)
end if
if request(“email”)<>“” then
    if instr(1,request(“email”),“@”)=0 then
        cerror=cerror & “Email is invalid.” & chr(13)
    else
        if instr(1,request(“email”),“.”)=0 then
            cerror=cerror & “Email is invalid.” & chr(13)
        else
            cresponse=cresponse & request(“email”) & chr(13)
        end if
    end if
else
    cerror=cerror & “Please enter an email” & chr(13)
end if
if nquestion_id=99999 or nanswer_id=99999 or (nquestion_id<>99999 and nanswer_id=0 and
nquestion_id<>0) then
    cerror=cerror & “Please provide an answer to the question.” & chr(13)
end if
```

### EXAMPLE #2

This section of code shows the database example of determining the user's identity.

```
bskip=“F”
cemail=trim(lcase(request(“email”)))
‘ find email
ipaddress=request.servervariables(“remote_addr”)
set Recordset1 = Server.CreateObject(“ADODB.Recordset”)
Recordset1.ActiveConnection = MM_connargustest_STRING
‘ determine user
if cemail<>“” then
    Recordset1.Source = “SELECT respondent_id FROM respondent WHERE
campaign_id=“ & ccampaign_id & “ and email=”‘ & cemail & ’””
    ‘response.write Recordset1.Source
else
    Recordset1.Source = “SELECT respondent_id FROM respondent WHERE
campaign_id=“ & ccampaign_id & “ and remote_addr=“‘ & ipaddress & ’” and datediff(mi,
date_modified, getdate( )) <=20 and email=””
end if
Recordset1.CursorType = 0
Recordset1.CursorLocation = 2
Recordset1.LockType = 3
Recordset1.Open( )
if not recordset1.eof then
    nrespondent_id=recordset1.fields.item(“respondent_id”).value
else
    if cemail<>“” then
        Recordset1.close( )
        Recordset1.Source = “SELECT respondent_id FROM respondent WHERE
campaign_id=“ & ccampaign_id & “ and remote_addr“‘ & ipaddress & ’” and datediff(mi,
date_modified, getdate( )) <=20 and email=””
        Recordset1.Open( )
        if not recordset1.eof then
            nrespondent_id=recordset1.fields.item(“respondent_id”).value
            bnew=“T”
        else
            nrespondent_id=0
        end if
    else
        Recordset1.close( )
        Recordset1.Source = “SELECT respondent_id FROM respondent WHERE
campaign_id=“ & ccampaign_id & “ and remote_addr=“‘ & ipaddress & ’” and datediff(mi,
date_modified, getdate( )) <=20”
        Recordset1.Open( )
        if not recordset1.eof then
            bskip=“T”
            nrespondent_id=0
        else
            nrespondent_id=0
        end if
    end if
end if
recordset1.close( )
```

### EXAMPLE #3

This section of code is an example of using the database to update content or insert content based on parameters provided from the user.

```
‘ store result
if bskip=“F” then
    if nrespondent_id<>0 then
        ‘if cemail<>“” then
        ‘ delete previous responses
        ‘Recordset1.close( )
        Recordset1.Source = “delete FROM survey_results WHERE respondent_id=” &
nrespondent_id & “ and answer_id in (select answer_id from answer a, question q where
a.question_id=q.question_id and q.question_id=” & nquestion_id & “)”
        ‘response.write Recordset1.Source
        Recordset1.Open( )
        ‘Recordset1.close( )
        Recordset1.Source = “update respondent set email = ”‘ & cemail & “’, lnm=”‘ &
request(“lnm”) & ’“, fnm=”‘ & request(“fnm”) & ’“, date_modified=getdate( ),
distribution_code=”‘ & disc_id & ’“, remote_addr=”‘ & ipaddress & ’“ where respondent_id=” &
nrespondent_id
        Recordset1.Open( )
        ‘end if
    else
        ‘ update name
        ‘ Recordset1.close( )
        Recordset1.Source = “select mid=max(respondent_id) from respondent”
        Recordset1.Open( )
        cmid=(recordset1.fields.item(“mid”).value) + 1
        Recordset1.close( )
        Recordset1.Source = “set identity_insert respondent on insert into respondent
(welcome, respondent_id, campaign_id, lnm, fnm, email, date_modified, date_created,
distribution_code, remote_addr) values (‘Y’,” & cmid & “,” & ccampaign_id & “,”‘ &
request(“lnm”) & ’“,”‘ & request(“fnm”) & ’“,”‘ & cemail & ’“,getdate( ), getdate( ),”‘ & disc_id &
’“,”‘ & ipaddress & ’“) set identity_insert respondent off”
        Recordset1.Open( )
        nrespondent_id=cmid
        bnew=“T”
    end if
    if nanswer_id > 0 then
        Recordset1.Source = “ insert into survey results (respondent_id, answer_id,
date_modified, date_created) values (” & nrespondent_id & “,” & nanswer_id & “,getdate( ),
getdate( ))”
        Recordset1.Open( )
    end if
end if
```

### EXAMPLE #4

This code example is a method of constructing an automated email complication from the server, to the user based on user specific parameters.

```
‘ send email welcome letter
if bnew=“T” then
        newstitle=“Welcome”
        set Recordset3 = Server.CreateObject(“ADODB.Recordset”)
        Recordset3.ActiveConnection = MM_connargustest_STRING
        Recordset3.CursorType = 0
        Recordset3.CursorLocation = 2
        Recordset3.LockType = 3
        Recordset3.Source = “select issue_id, from_email, issue_title, issue_subject,
greeting_name, greeting_email, greeting_dear, issue_type, issue_text from nw_issue where
issue_title=”‘ & newstitle & ’“”
        Recordset3.Open( )
        issue_id=recordset3.fields.item(“issue_id”).value
        issue_text=recordset3.fields.item(“issue_text”).value
        issue_subject=recordset3.fields.item(“issue_subject”).value
        greeting_name=recordset3.fields.item(“greeting_name”).value
        greeting_email=recordset3.fields.item(“greeting_email”).value
        greeting_dear=recordset3.fields.item(“greeting_dear”).value
        issue_type=recordset3.fields.item(“issue_type”).value
        from_email= recordset3.fields.item(“from_email”).value
        set cdomail=server.createobject(“CDONTS.newmail”)
        cdomail.from = from_email
        cdomail.to=cemail
        cbody=“”
        cdomail.subject = cbody + issue_subject
        if greeting_name=“Y” then
            cbody=ltrim(rtrim(request(“fnm”)))+“ ”+request(“lnm”)
            if issue_type=“H” then
                cbody=cbody + “<br>”
            else
                cbody=cbody + chr(13)
            end if
        end if
        if greeting_email=“Y” then
            cbody=cbody & cemail
            if issue_type=“H” then
                cbody=cbody + “<br><br>”
            else
                cbody=cbody + chr(13) + chr(13)
            end if
        end if
        if greeting_dear=“Y” then
            cbody=cbody & “Dear ”+ ltrim(rtrim(request(“fhm”)))+“,”
            if issue_type=“H” then
                cbody=cbody + “<br><br>”
            else
                cbody=cbody + chr(13) + chr(13)
            end if
        end if
if issue_type=“H” then
            cdomail.bodyformat = 0
            cdomail.mailformat = 0
            HTML = “<!DOCTYPE HTML PUBLIC ”“-//IETF//DTD
HTML//EN”“>” & vbCrLf
            HTML = HTML & “<html>”
            HTML = HTML & “<head>”
            HTML = HTML & “<meta http-equiv=”“Content-Type”“”
            HTML = HTML & “content=”“text/html; charset=iso-8859-1 ”“>”
            HTML = HTML & “<title>Preview Mail</title>”
            HTML = HTML & “</head>”
            HTML = HTML & “<body>”
            cdomail.body = html + cbody + issue_text + “</body></html>”
        else
            cdomail.body = cbody + issue_text
            cdomail.bodyformat = 1
            cdomail.mailformat = 1
        end if
        cdomail.send
        set cdomail=nothing
end if
‘ send response to CD-ROM or DVD
if cerror=“” then
    cresponse = cresponse + chr(13) + “Thank you for filling out the survey. You will be
notified by email if you are a winner.”
‘ cresponse=“error=”+replace(cresponse,“ ”,“+”)
    response.write cresponse
else
    cerror=cerror + chr(13) + “There were errors on the form, please try again.”
‘ cerror=“error=”+replace(cerror,“ ”,“+”)
    response.write cerror
end if
‘response.write chr(13) + “last name=” + request(“lnm”)
‘response.write “; first name=” + request(“fnm”)
‘response.write “; email=” + request(“email”)
‘response.write “; question_id=” + nquestion_id
‘response.write “; answer_id=” + nanswer_id
%>
```

Although the technology disclosed above applies in many business models and situations, this system can be marketed as a Direct Marketing piece to promote the products and services of Fortune 500 companies. These companies can replace traditional printed marketing materials with the new solution described herein.

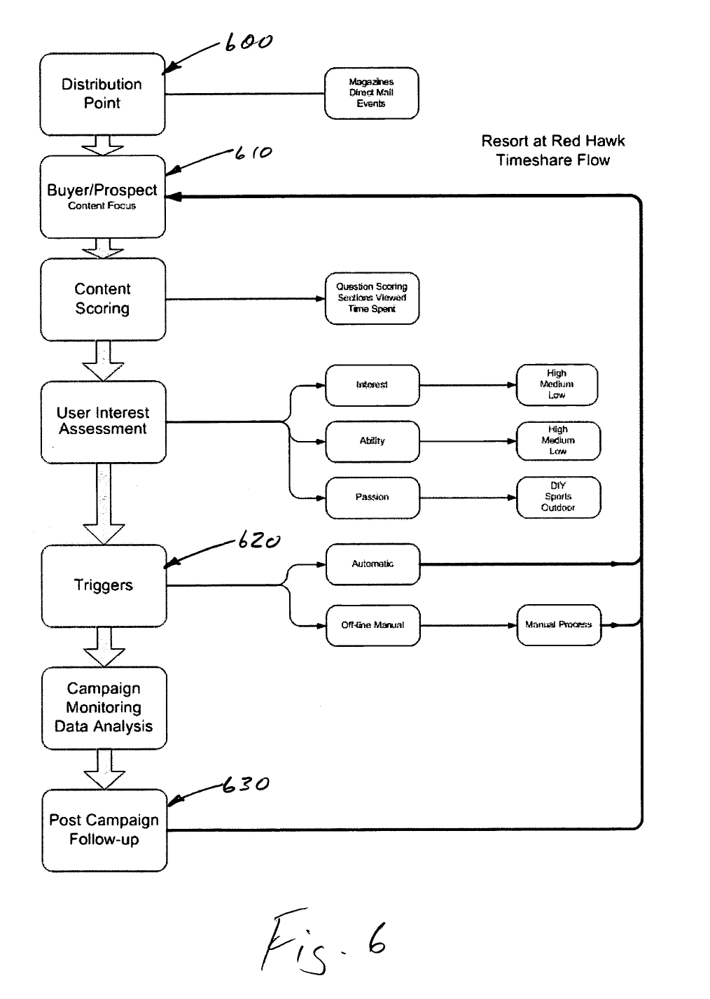

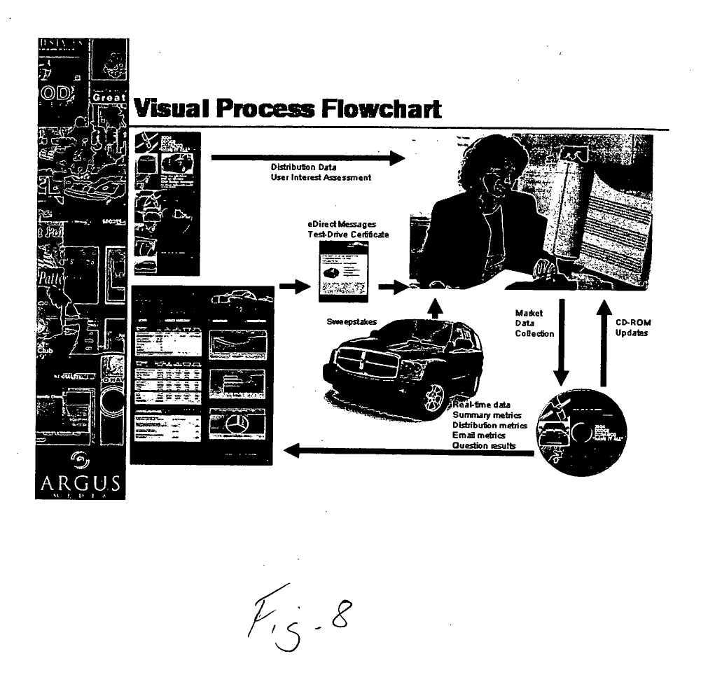

By way of example, FIGS. 6 and 8 illustrate one overview of the entire system. A distribution means (600) or several other means are determined. A buyer (610) receives a content storage medium such as a CD-ROM or DVD. The storage medium contains a program that executes locally on the prospect's computer and interacts remotely with a server computer. The server is gathering and sorting information such as the answers to questions, how long a user spends in an area of the CD-ROM. This information is placed into a marketing campaign monitoring system that a company will use for real-time analysis of the marketing campaign. This server system also has the ability to reply using email to the user based on certain trigger points (620). The server system contains complete marketing campaign monitoring graphs, charts and data about the user. When a marketing campaign is complete, the system allows for a follow-up (630) by the company using the system through an integrated email system.

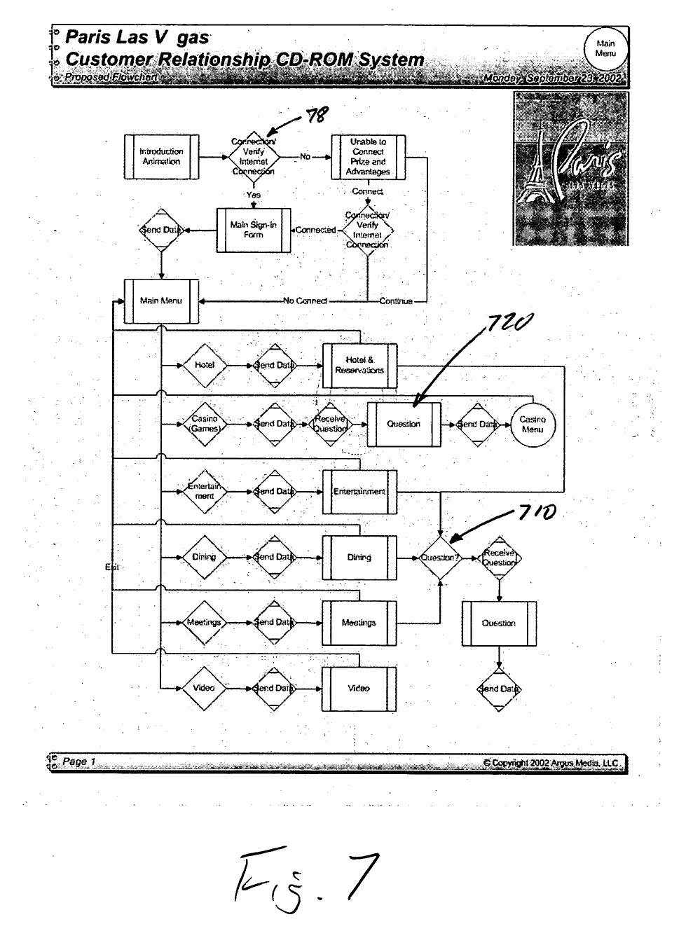

In an example of actual use of the disclosed system as shown in FIG. 7, a storage device, such as a CD-ROM is produced and distributed through direct mail or several other means to a user. The user plays the CD-ROM in her computer. The storage device finds a connection (700), automatically connects or prompts the user for a connection to a network, which can be the Internet or any other network, wireless or wired. A connection to a server is established and certain pre-coded information such as the distribution point is collected into the server's database. As the user moves through the multimedia content on the storage device, the program will prompt the user for information (710, 720). As the user supplies this information the content may adjust to the needs of the user. The server will supply variable content based on the user's desires. It will also find the most current information on the server and replace the default information supplied on the CD-ROM. The user is unaware of this update. For instance a list of events with dates and times would adjust to the current list.

An entity who whishes to market the present invention can charge a client for a number of different items such as: a per piece (storage device) fee; the creative and developmental processes associated with a client's marketing campaign; the use of a campaign monitoring system for its servers and system management; and for licensing of the technology.

The foregoing is a detailed description of preferred embodiments, not all possible embodiments. It is therefore to be understood that the embodiments of the present invention described hereinabove are merely illustrative and that other modifications and adaptations may be made.

What we claim is:

1. A method of distributing multimedia marketing content and collecting marketing data, the method comprising the steps of:
A. generating a plurality of auto-loading storage devices containing automatically loadable multimedia marketing content and one or more automatically loadable marketing data collection programs;
B. providing a multimedia content serving system and a marketing data collection system on a communications network;
C. sending the auto-loading storage devices to remote users, each said remote user having use remote computing apparatus, whereby each remote user should receive at least one among the plurality of auto-loading storage devices;
D. causing the multimedia content serving system and data collection system to:
i. automatically network link with remote user apparatus through the communications network when one or more remote users access the multimedia content serving system and data collection system through the remote user's remote computing apparatus;
ii. for each said accessing remote user: (a) automatically transferring second automatically loadable multimedia marketing content to the remote user's remote computing apparatus, whereby the remote computing apparatus may automatically play the second automatically loadable multimedia marketing content; and (b) automatically receiving and processing remote user marketing data transferred from the remote user's remote computing apparatus by the automatically loadable marketing data collection program running on the remote user's remote computing apparatus.

2. The marketing content distribution and information collection method of claim 1 wherein the auto-loading storage devices comprise digital storage media and the communications network comprises the Internet.

3. The marketing content distribution and information collection method of claim 1 wherein multimedia content serving system and marketing data collection system cooperatively communicate with web site systems, whereby each accessing user's computing apparatus may receive second automatically loadable multimedia content and transfer remote user marketing data to said marketing data collection system.

4. The marketing content distribution and information collection method of claim I wherein multimedia content serving system and marketing data collection system cooperatively communicate with web site systems, whereby each accessing user's computing apparatus may receive second automatically loadable multimedia content and transfer remote user marketing data to said marketing data collection system.

5. The marketing content distribution and information collection method of claim 1 also including receiving revenue from a third party in connection with distributing the third party's marketing content by performing steps A-D.

6. The marketing content distribution and information collection method of claim 4 also including receiving revenue from a third party in connection with distributing the third party's marketing content by performing steps A-D.

7. The marketing content distribution and information collection method of claim 1 in which the sending step (C) comprises sending the auto-loading storage devices by a manual shipping service.

8. The marketing content distribution and information collection method of claim 2 in which the sending step (C) comprises sending the auto-loading storage devices by a manual shipping service.

9. The marketing content distribution and information collection method of claim 5 in which the sending step (C) comprises sending the auto-loading storage devices by a manual shipping service.

10. The marketing content distribution and information collection method of claim 6 in which the sending step (C) comprises sending the auto-loading storage devices by a manual shipping service.

11. The marketing content distribution and information collection method of claim 5 wherein the remote user marketing data processing step D(ii) further comprises distributing remote user marketing user data to said third party.

12. The marketing content distribution and information collection method of claim 6 wherein the remote user marketing data processing step D(ii) further comprises distributing remote user marketing user data to said third party.

13. The marketing content distribution and information collection method of claim 9 wherein the remote user marketing data processing step D(ii) further comprises distributing remote user marketing user data to said third party.

14. The marketing content distribution and information collection method of claim 10 wherein the remote user marketing data processing step D(ii) further comprises distributing remote user marketing user data to said third party.
